(19) United States
(12) Patent Application Publication
(10) Pub. No.: US 2006/0054225 A1
(43) Pub. Date: Mar. 16, 2006

(54) Proportional pressure control valve

(76) Inventors: Thorsten Hillesheim, Schemmerhausen (DE); Peter Bruck, Althornbach (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/544,105

(22) PCT Filed: Apr. 8, 2004
(86) PCT No.: PCT/EP04/03758

§ 371 Date: Aug. 2, 2005

(30) Foreign Application Priority Data
Jun. 4, 2003 (DE) 103251782

(51) Int. Cl. F15B 13/043

(52) U.S. Cl. 137/625.64

(57) ABSTRACT

The invention relates to a proportional pressure control valve comprising a valve housing (10) with at least three ports that conduct fluid, in particular in the form of a pump port (P), a utilisation port (A) and a tank port (T), a regulating piston (18) being configured to be displaced longitudinally in the valve housing (10) for the selective connection of the pump port (P) to the utilisation port (A), or of the utilisation port (A) to the tank port (T). Said piston is provided with a connection channel (24) for establishing a fluidic connection between the pump port (P) and a servo chamber (20) of a servo valve (22), the latter (22) being controlled by a magnetic system (28), in particular a proportional magnetic system. When the servo valve (22) is open, the fluidic path (58) that is partially guided through the valve housing (10) between the connection channel (24) and the tank port (T) is released, the latter having a simultaneous fluidic connection to the utilisation port (A).

The invention relates to a proportional pressure control valve with a valve housing, having at least three fluid-conducting ports, in particular in the form of a pump P, a utility A, and a tank T port, it being possible to displace longitudinally inside the valve housing for the purpose of optional connection of the pump port P to the utility port A and the utility port A to a tank port T, a control piston which is provided for establishment of a fluid-conducting connection between the pump port P and a servo chamber of a pilot control valve with a connecting channel, the pilot valve being actuatable by a magnet system, a proportional magnet system in particular.

A generic proportional pressure control valve such as this has been disclosed in U.S. Pat. No. 6,286,535 B1. In this disclosed solution the pump port P communicates in the axial direction of displacement of the control piston inside the valve housing with the latter, while the other two ports in the form of a utility port A and a tank port T communicate transversely thereto in the radial direction, on appropriate ordering of displacement of the control piston in an annular space, with the annular space being bounded on one side by the valve housing and on the other side by the control piston itself. In addition, a damping screen is provided in the control piston in the disclosed solution, a screen which permanently connects a damping chamber between valve housing and control piston to the annular space referred to. In this way the transient effects of the control piston may be suitably damped, the dynamics nevertheless being simultaneously higher for the valve as a whole, something which is necessary if such proportional pressure control valves are employed by preference in coupling systems which serve, for example, to connect two shafts such as the shafts of machines to transmission shafts.

As a further development of this disclosed solution U.S. Pat. No. 5,836,335 discloses proportional pressure control valves in which the control piston has a mechanism for limiting pressure peaks such as may otherwise occur, for example, in utility port A to which the couplings may be connected. In a preferred embodiment of the disclosed valve a spring-loaded return valve is introduced into the control piston, which may be connected by way of the annular space to that of the utility port and at an assigned pressure threshold clears the fluid-conducting path between the annular space and an encircling groove in the control piston, which groove is permanently connected to the tank port.

It has been found in practical application that, when the respective proportional pressure control valves are used in couplings, not only does it occur that these couplings are characterized by high switching dynamics with simultaneously low pressure losses, so that rapid processes of charging with the hydraulic medium and rapid discharging of the coupling may be ensured but also it is important to keep obstructions from occurring in the coupling so that the valves in question used for this application may be completely relieved. That is, when the electric control signal on the magnet system is removed by which the valve is actuated, the adjusted pressure on utility port A, which leads to the actuating mechanism of the coupling, is reset to a value of 0 bar. In the case of the pressure valves traditionally available, those specified in the two US patents referred to, however, the control piston (so-called main stage of the valve) is returned to its end position by a pressure spring under tension and, because of the structural design, these valves are still at a level of pressure when the electric control signal of the magnet system is not present which corresponds to the force of the valve spring under tension. This extant residual pressure may operate against an effective process of opening the hydraulic coupling, something which in practical application results in obstructions or even makes an uncoupling process impossible.

On the basis of this prior art, then, the object of the invention is to retain the advantages of the disclosed solutions while improving these solutions by creating a valve system which can provide assurance that a pressure value of 0 bar is set at the utility port A when the magnet system is not in operation in order to ensure high reliability of operation in use of coupling systems. The object as thus formulated is attained by a proportional pressure control valve having the features specified in claim 1 in its entirety.

In that, as specified in the descriptive part of claim 1, when the pilot control valve is open it clears the fluid conducting path extending in part through the valve housing, between the connecting channel and the tank port T, which is simultaneously connected to the utility port A to conduct fluid, a valve is created which may be completely discharged, with the result that, when the electronic control signal in the magnet system is removed, the pressure controlled by the control piston at utility port A definitely assumes the pressure value of 0. Thus, since the solution claimed for the invention dispenses with returning the control piston (main stage) to its end position by means of a pressure spring under tension, it makes certain that, especially in the case of an application involving couplings, the latter may be fully released, so that the coupling or disk pack which otherwise are engaged are reliably separated from each other and the coupling connection is thus broken.

Other advantageous embodiments of the proportional pressure control valve claimed for the invention are specified in the dependent claims.

The proportional pressure control valve claimed for the invention will be described in detail below with reference to an exemplary embodiments illustrated by the drawing, in which, in the form of diagrams not drawn to scale,

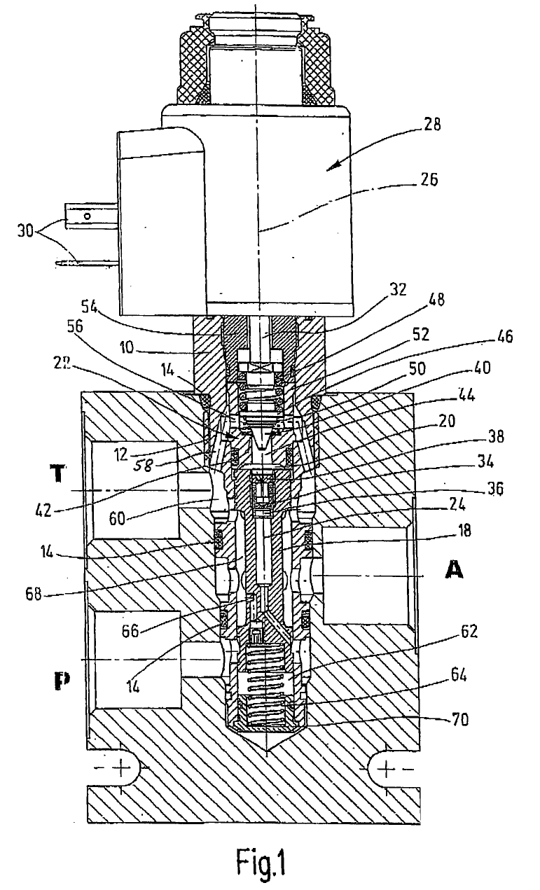

FIGS. 1 to 3 present, partly as a side view and partly as a longitudinal section, the proportional pressure control valve claimed for the invention in various switched or actuation positions;

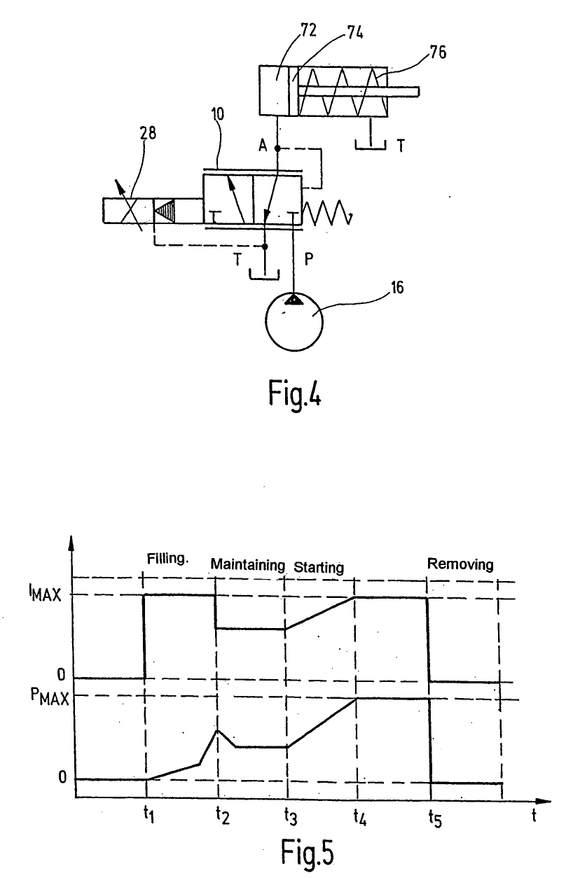

FIG. 4 presents, as a simplified connection diagram, use of the proportional pressure control valve shown in FIGS. 1 to 3 for application in the instance of a multidisk clutch;

FIG. 5 presents the course of a coupling cycle for a coupling-valve configuration in accordance with the configuration shown in FIG. 4.

The basic structure of the proportional pressure control valve claimed for the invention is illustrated in FIG. 1. It has a valve housing 10 configured as a screw-in cartridge, which may be moved over a screw-in path 12 into a machine part not shown, such as one in the form of a valve block or the like. The valve housing 10 is provided on the outer circumference with appropriate sealing rings 14 and associated recesses for the sealing system of the respective system. The valve housing 10 has in the radial circumference direction, from top to bottom as viewed in the direction of FIG. 1, a tank port T, a utility port A, and a pump port P for a hydraulic pump 16 (see FIG. 4). In addition, a control piston 18 which may be displaced longitudinally inside the valve housing 10 is provided for optional connection of the pump port P to the utility port A and also of the utility port A to the tank port T.

For the purpose of establishing a fluid-conducting connection between the pump port P and a servo chamber 20 of a pilot valve designated as a whole as 22, the control piston 18 is provided with a connecting channel 24 which extends through the center of the control piston 18 in the longitudinal direction 26 of the entire valve, the lower end of the connecting channel 24 being bent at an angle and thus pointing in the direction of the pump port P. In addition, the pilot valve 22 in question may be actuated by way of a magnet system designated as a whole as 28, in particular one in the form of a proportional magnet system. Magnet systems 28 such as these regularly have a wire-wound coil (not shown) through which current is to flow, the magnet system 28 having a plug connection component 30. If the proportional magnet system 28 is supplied with current by way of a plug connection component 30, the wire-wound coil (not shown) is controlled by an operating tappet 32 so that, as viewed in the direction of FIG. 1, it moves downward, and accordingly the pilot valve 22 proper remains in its closed position as shown in FIG. 1. The respective structure of a magnet system 28 and its operation are known in the prior art and will not be discussed in detail at this point.

In the direction of the servo chamber 20 of the pilot valve 22 the connecting channel 24 has a screen 34. A protective screen 36 is mounted upstream from the screen 34 in the direction of fluid flow, while a so-called diffuser 38 is provided downstream from the screen 34. The diffuser 38 serves the purpose primarily of diverting the guided oil stream from the screen 34 so that this stream will not strike the closing or valve component 40 of the pilot valve 22 directly, something which could result in malfunctions in certain valve states. In addition, the possibility exists in principle of creating an valve variation for the proportional pressure valve, of employing a diffusor with additional screen bore (not shown) which is particularly well suited for high pump pressures (primary pressures). The protective screen 36 makes it possible to filter fouling substances out of the stream of fluid.

The servo chamber 20 referred to in the foregoing is part of a valve seat 42 mounted in the valve housing so as to be stationary in the valve housing 10, the valve seat 42 being connected by a center channel 44 to the servo chamber 20. As is shown in FIG. 1, this valve seat 42 may be brought into sealing contact with the valve component 40 of the pilot valve 22, it being possible to move the valve component 40 under the force of a spring in the direction of the servo chamber 20 into its closed position shown in FIG. 1. For the purpose of contact with the valve seat itself 42 the valve component 40 is provided on its front lower end as viewed in the direction of FIG. 1 with a tapering closing or valve tip. This tip is an integral component of the valve guide plate 46 which is engaged on both sides with a pressure spring 48, 50. The first pressure spring 48 extends between the valve guide plate 46 in question and a flange-like widening on the lower end of the operating tappet 32. The second pressure spring 50, which is weaker with respect to its spring force than the first pressure spring 48, extends by its two free ends between the valve guide plate 46 and the upper side of the valve seat 42. For the purpose of better control of these pressure springs 48, 50 the valve guide plate 46 may, as is shown in FIG. 1, be provided on both sides with a cylindrical guide or contact attachment.

For the purpose of control of the valve guide plate 45 there is provided inside the valve housing 10 a guide component 52 which, designed as a sort of cylindrical sleeve, is rigidly connected to the valve housing. A screw-in component 54 by means of which the proportional magnet system 28 may be mounted and secured on the valve housing 10 is present between the guide component 52 and the magnet system itself 28. In addition, the operating tappet 32 is controlled by its flange-like widening on its one free end inside this screw-in component 54. The guide component 52 also delimits by its stationary valve seat 42 a distribution compartment 56 configured as an annular channel. There is a fluid-conducting path 58 extending in the valve housing 10 which is permanently connected to this distribution compartment 56 and the other end of which communicates with a connecting compartment 60 delimited by the outer circumference of the valve housing 10 and by the inner circumference of the valve unit or machine component (not shown) into which the valve housing 10 may be introduced and with which the tank port T of the valve housing 10 communicates.

Hence, a permanent connection between tank port T and the distribution compartment 56 is thereby achieved by way of the fluid-conducting path 58. As is shown in FIG. 1, the fluid-conducting path 58 may be in the form of a plurality of individual channels which extend through the valve housing, tapering in the direction of the operating tappet 32, at the level of the screw-in path 12 of the latter. The end of these individual channels pointing in the direction of the tank port T as viewed in the direction of FIG. 1 communicates with the exterior or the connecting compartment 60 below the lower end of the screw-in path 12. On the basis of this structure of the pilot valve 22 as described in the foregoing the latter is thus configured as a proportional pressure control valve.

As is also to be seen in FIG. 1, the control piston 18 with the valve housing 10 adjoins a damping chamber 62 on its one end facing away from the servo chamber 20. There is mounted in this damping chamber 62 an energy accumulator, in particular one in the form of a pressure spring 64 which tends to displace the control piston 18 in the direction of the servo chamber 20. The damping chamber 62 is connected by way of a damping screen 66 mounted in the control piston 18 to an annular space 68 enclosing the control piston 18, this annular space being delimited toward the exterior by the inside of the valve body 10. This annular space 68 optionally connects the tank port T to the utility port A or the utility port A to the pump port P, as a function of the longitudinal or displacement position of the control piston 18 in the valve housing 10. The damping chamber 62 is both enclosed by the inside of the valve housing 10 and delimited on one side by the control piston 18 and on the opposite side by a lift stop 70 for the control piston 18. The lift stop 70 proper is in the form of a free side which faces the control piston 18, and this lift stop 70 also forms the end of the valve housing 10 on one side of the latter.

Now that the basic features of the structural design of the proportional pressure control valve claimed for the invention have been described, the functioning of this valve will be discussed with reference to FIGS. 1 to 3.

So long as current does not flow through the proportional magnet system 28, hydraulic medium (oil) may flow from the pump port P to the tank port T. When the valve is in this state, accordingly, the pilot valve 22 shown in FIG. 1 has been opened and the upper stop of the control valve 18 has moved to come into contact with the lower side of the valve seat 42. In this switching position oil flows from the pump port P through the control piston 18, specifically, by way of the connecting channel 24, and through the combination of protective screen 36, screen 34, and diffusor 38 and from there by way of the opened pressure limitation valve (pilot valve) 22 of the pilot control toward the tank. The forces of the second pressure spring 50 suffice, in conjunction with the pump pressure by way of the center channel 44, to lift the valve guide plate 46 with the valve component 40 against the action of the first pressure spring 48. The hydraulic medium then reaches the distribution compartment 56 by way Of the center channel 44 and from here flows by way of the fluid-conducting path 58 into the connecting compartment 60, which, together with the tank port T, leads to the tank. The respective volume flow may be defined as pilot control oil flow or leakage.

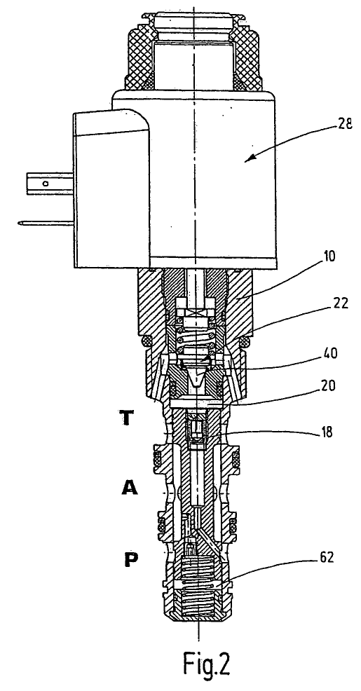

When current is applied to the proportional magnet system 20 by an upstream electronic system (not shown), the closing or valve component 40 of the pilot valve 22 moves into contact with the seat edge of the valve seat 42, thereby interrupting the volume flow between the pump port P and the tank port T. The respective switching state is illustrated in FIG. 2. The servo chamber 20 is accordingly filled with the hydraulic medium, as a result of which the pressure in this chamber increases. This pressure acts on the upper, front, side of the control piston 18 and moves it in the direction of the lower lift stop 70, against the force of a third pressure spring 64 undergoing compression. The pressure in the servo chamber 20 then corresponds to the adjusted pressure.

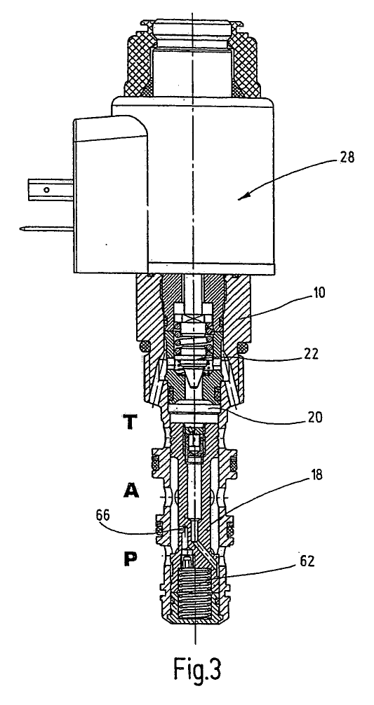

If the pressure in the damping chamber 62 is lower than the pressure in the servo chamber 20, the control piston occupies a position such that the consumer device port A is connected to the pump port P. The respective switched position is reproduced in FIG. 3. The pressure on the utility port A is reported to the damping compartment by way of the damping screen 66 and acts there on the front side of the control piston 18 as a force opposed to the pressure level in the servo chamber 20. If the pressure in the damping chamber 62 reaches the adjusted pressure, the control piston 18 is displaced so that the connection between the pump port and the utility or consumer device port A is throttled. The control piston 18 moves to a position in which the two force levels are in balance with each other and define a window opening between the pump port P and the utility port A. Hence, a pressure is established at the utility port A which is directly related to the electric control signal of the magnet system 28. As a result of the adjustment of the defined secondary pressure a volume of oil is moved back and forth constantly by way of the damping screen 66 between the damping chamber 62 and the utility port A, so that the control process is damped in such a way as to prevent disruptive oscillations during this adjustment process.

The proportional pressure control valve claimed for the invention is one which may be used to advantage especially for coupling applications. The main requirements for high dynamics and low pressure losses are set for such applications in order to make it possible to ensure a rapid process of filling with oil and rapid emptying of the coupling. This is achieved directly with the present valve configuration, and in addition the load on the valve claimed for the invention may be completely removed, that is, when the electric control signal is completely removed from the magnet system 28, the adjusted pressure on the utility port A is reduced to a value of 0 bar. With the otherwise customary servo pressure valves the respective main stage (control piston) is returned to its end position by a pressure spring under tension, so that the disclosed valves are always at a pressure level with an electric control signal not present at the magnet system which corresponds to the force of the spring under tension. This situation results in problems in release of hydraulically operated couplings.

In order to make this clear, use of the proportional pressure control valve claimed for the invention is described in greater detail with reference to FIGS. 4 and 5 for a hydraulically operated coupling. The illustration and FIG. 4 show that the proportional pressure control valve is connected between coupling points 72, 74, 76 and the hydraulic pump 16. Couplings serve among other things to connect two shafts, such as the shafts of machines and transmission shafts. In the case of the respective hydraulic coupling a cylinder space 72 is connected to the pressurized line or pressure port P of the hydraulic pump 16 by actuation of the proportional pressure control valve claimed for the invention. The spring-loaded piston 74 presses together a disk pack not shown. The cylinder space 72 is then emptied as a result of reversal of the proportional pressure control valve and the pressure spring configuration 76 pushes the piston 74 back to its initial position, as is shown in FIG. 4. In the process the remaining hydraulic medium is forced out by way of the utility port A in the direction of the tank T.

The illustration in FIG. 5 shows the sequence of a coupling event. The coupling must first be rapidly filled with oil (hydraulic medium). This takes places over time interval t₁ to t₂; the piston 74 begins to compress the disk pack precisely as a result of this process. This process involves a brief, very high volume flow. This state is maintained over time interval t₂ to t₃ and the process is slowly Astarted@ over time interval t₃ to t₄, the pressure undergoing slow linear increase as a result of operation of the proportional pressure control valve, so that the force of the machine is transmitted uniformly to the transmission string. At time t₅ the pressure in the coupling is removed as a result of backing up of the electric control signal on the magnet system 28, so that the compressed disk pack may push the piston 74 back to its initial position under the additional influence of the pressure spring configuration 76, something which is immediately possible, since in the switched position already illustrated the pressure at port A assumes the value of 0.

1. A proportional pressure control valve with a valve housing (10) having at least three fluid-conducting connections, in particular in the form of a pump (P), a utility (A), and a tank (T) port, it being possible to displace longitudinally inside the valve housing (10), for the purpose of optional connection of the pump port (P) to the utility port A and connection of the utility port (A) to the tank port (T), a control piston (18) which is provided for establishment of a fluid-conducting connection between the pump port (P) and a servo chamber (20) of a pilot valve (22) with a connecting channel (24), the pilot valve (22) being actuatable by a magnet system (28), a proportional magnet system in particular, characterized in that, when the pilot valve (22) has been opened, such pilot valve (22) opens the fluid-conducting path (58) leading partly through the valve housing (10) between the connecting channel (24) and the tank port (T), which is simultaneously connected to the utility port (A) so as to conduct fluid.

2. The proportional pressure control valve as claimed in claim 1, wherein the connecting channel (24) has a screen (34), by preference a screen (34) with a protective screen (36) connected upstream and/or a diffusor (38) connected downstream, in the direction of the servo chamber (22) of the pilot valve (22).

3. The proportional pressure control valve as claimed in claim 1, wherein the servo chamber (20) is part of a valve seat (42) mounted in the valve housing (10) so as to be stationary, which valve seat (42) is connected to the servo chamber (20) so as to conduct fluid and may be moved into contact with a valve component (40) of the pilot valve (22) so as to effect closing, which valve component (40) of the pilot valve (22) may be moved by the force of a spring to its closed position in the direction of the servo chamber (20).

4. The proportional pressure control valve as claimed in claims 1, wherein the control piston (18) delimits, on its one end facing away from the servo chamber (20) together with the valve housing (10), a damping chamber (62) in which a force accumulator, in particular one in the form of a pressure spring (64), tends to displace the control piston (18) in the direction of the servo chamber (20)

5. The proportional pressure control valve as claimed in claim 4, wherein the damping chamber (62) is connected by way of a damping screen (66) mounted in the control piston (18) to an annular space (68) by which optionally the tank port (T) communicates with the utility port (A) or the utility port (A) communicates with the pump port (P) as a function of the longitudinal position of the control piston (18) in the valve housing (10).

6. The proportional pressure control valve as claimed in claim 4, wherein the damping chamber (62) is enclosed by the valve housing (10) and on one of its sides by the control piston (18) and on its opposite side by a lift stop (70) for the control piston (10), which closes of the valve housing (10) from the exterior on its one free side.

7. The proportional pressure control valve as claimed in claims 1, wherein the pilot valve (22) is configured as a proportional pressure control valve.

8. The proportional pressure control valve as claimed in claims 3, wherein the valve component (40) of the pilot valve (22) is conducted between two force accumulators in the form of pressure springs (48, 50) so as to be movable longitudinally in a guide component (52) which is mounted so as to be stationary and with the valve seat (42) adjoins a distribution compartment (56) to which the fluid-conducting path (10) is permanently connected.

9. The proportional pressure control valve as claimed in claim 1, wherein all fluid-conducting ports (A, P, T) extend through the valve housing (10) in the radial direction.

10. The proportional pressure control valve as claimed in claims 1 for hydraulically actuatable couplings in which a cylinder space (72) of the couplings is to be connected to a hydraulic pump (16) by way of the valve for the purpose of compression of a disk pack.
